(19) United States
(12) Patent Application Publication
(10) Pub. No.: US 2024/0305122 A1
(43) Pub. Date: Sep. 12, 2024

(54) DIRECT CURRENT FAST CHARGE METHOD FOR CHARGING BATTERY CELLS INCLUDING LITHIUM SILICON OXIDE (LSO)

(71) Applicant: GM Global Technology Operations LLC, Detroit, MI (US)

(72) Inventors: Dewen KONG, Shanghai (CN); Si Chen, Shanghai (CN); Haijing Liu, Shanghai (CN); Mark W. Verbrugge, Sonoma, CA (US)

(21) Appl. No.: 18/361,253

(22) Filed: Jul. 28, 2023

(30) Foreign Application Priority Data
Mar. 6, 2023 (CN) 202310208962.5

(51) Int. Cl. H02J 7/00

(52) U.S. Cl. CPC H02J 7/007182; H02J 7/0048; H02J 7/007194

(57) ABSTRACT

A method includes determining a state of charge (SOC) of the battery and charging the battery using a plurality of charging steps. If the SOC of the battery is less than a predetermined SOC, the battery is charged at a first charge rate (C-rate) in a range from 3 C to 4 C in a first step until the SOC of the battery increases by a first ΔSOC. After the first ΔSOC, the battery is charged in the constant current mode at a second C-rate of 3−(1/n) C in a second step to (2+n−1)^{th} step until the SOC of the battery increases by a second ΔSOC, where n is an integer greater than zero. After the second ΔSOC, the battery is charged in the constant current mode at a third C- rate of 2+ (1/n) C in a (2+n)^{th} step until the SOC of the battery increases by a third ΔSOC.

### CROSS-REFERENCE TO RELATED APPLICATIONS

This application claims the benefit of Chinese Patent Application No. 202310208962.5, filed on Mar. 6, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to methods for charging battery packs, and more particularly to methods for charging battery packs including lithium silicon oxide (LSO) containing battery cells.

Battery electric vehicles include a battery pack with one or more battery modules including a plurality of battery cells. The amount of time required to recharge the battery pack has been a limiting factor to more widespread adoption of EVs. For example, when an EV is not located at a home of the operator and requires a recharge, it may take significantly longer than the amount of time required to refuel a vehicle including an internal combustion engine.

### SUMMARY

A method for charging a battery includes determining a state of charge (SOC) of the battery; charging the battery using a plurality of charging steps including: if the SOC of the battery is less than a predetermined SOC, charging the battery in a constant current mode at a first charge rate (C-rate) in a range from 3 C to 4 C in a first step until the SOC of the battery increases by a first ΔSOC; after the first ΔSOC, charging the battery in the constant current mode at a second C-rate of 3−(1/n) C in a second step to (2+n−1)th step until the SOC of the battery increases by a second ΔSOC, where n is an integer greater than zero; and after the second ΔSOC, charging the battery in the constant current mode at a third C-rate of 2−(1/n) C in a (2+n)th step until the SOC of the battery increases by a third ΔSOC.

In other features, the plurality of charging steps further comprise, after the third ΔSOC, charging the battery in the constant current mode at a fourth C-rate of 2−(1/m) C in a (2+n+1) step to a (2+n+m-1) step until the SOC of the battery increases by a fourth ΔSOC, where m is an integer greater than zero. The plurality of charging steps further comprise, after the fourth ΔSOC, charging the battery in the constant current mode at a fifth C-rate of 1+(1/m) C in a (2+n+m)th step until the SOC of the battery increases by a fifth ΔSOC. The plurality of charging steps further comprise, after the fifth ΔSOC, charging the battery in the constant current mode at a sixth C-rate of 1−(1/p) C in a (2+n+m+1)th step to a (2+n+m+p−1)th step until the SOC of the battery increases by a sixth ΔSOC, where p is an integer greater than zero.

In other features, the plurality of charging steps further comprise, after the sixth ΔSOC, charging the battery in the constant current mode at a seventh C-rate of (1/p) C in a (2+n+m+p)th step until the SOC of the battery increases by a seventh ΔSOC. The plurality of charging steps further comprise, after the seventh ΔSOC, charging the battery in a constant current/constant voltage mode at an eighth C-rate of (1/p) C in a (2+n+m+p+1)th step until the SOC of the battery increases by a eighth ΔSOC.

In other features, the method includes skipping to a next charging step in the plurality of charging steps in response to a battery cell voltage of the battery exceeding a predetermined battery cell voltage. The method includes skipping to a next charging step in the plurality of charging steps in response to a temperature of the battery in a current step increasing by more than a predetermined temperature difference. The predetermined SOC is less than 10%.

In other features, the first ΔSOC, the second ΔSOC, the third ΔSOC, the fourth ΔSOC, the fifth ΔSOC, the sixth ΔSOC, the seventh ΔSOC, and the eighth ΔSOC are in a range from 2% to 10%. 3≤n≤15, 3≤m≤10, and 3≤p≤6. The method includes reducing a C-rate to a predetermined C-rate range for a predetermined period after one or more of the plurality of charging steps.

In other features, the one or more of the plurality of charging steps have one or more C-rates selected from a group consisting of 3 C to 4 C, 3−(1/n) C, 2+(1/n) C, and 2−(1/m) C. The predetermined C-rate range is from 0.1 C to 1 C. The predetermined period is in a range from 1 minute to 2 minutes.

A method for charging a battery includes determining a state of charge (SOC) of the battery; charging the battery in a plurality of charging steps including: if the SOC of the battery is less than a predetermined SOC, charging the battery in a constant current mode at a first charge rate (C-rate) in a range from 3 C to 4 C in a first step until the SOC of the battery increases by a first ΔSOC; after the first ΔSOC, charging the battery in the constant current mode at a second C-rate of 3−(1/n) C in a second step to (2+n−1)th step until the SOC of the battery increases by a second ΔSOC, where n is an integer greater than zero; and after the second ΔSOC, charging the battery in the constant current mode at a third C-rate of 2+(1/n) C in a (2+n)th step until the SOC of the battery increases by a third ΔSOC; after the third ΔSOC, charging the battery in the constant current mode at a fourth C-rate of 2−(1/m) C in a (2+n+1) step to a (2+n+m-1) step until the SOC of the battery increases by a fourth ΔSOC, where m is an integer greater than zero; after the fourth ΔSOC, charging the battery in the constant current mode at a fifth C-rate of 1+(1/m) C in a (2+n+m)th step until the SOC of the battery increases by a fifth ΔSOC; after the fifth ΔSOC, charging the battery in the constant current mode at a sixth C-rate of 1−(1/p) C in a (2+n+m+1)th step to a (2+n+m+p−1)th step until the SOC of the battery increases by a sixth ΔSOC, where p is an integer greater than zero; after the sixth ΔSOC, charging the battery in the constant current mode at a seventh C-rate of (1/p) C in a (2+n+m+p)th step until the SOC of the battery increases by a seventh ΔSOC; and after the seventh ΔSOC, charging the battery in a constant current/constant voltage mode at an eighth C-rate of (1/p) in a (2+n+m+p+1)th step until the SOC of the battery increases by an eighth ΔSOC.

In other features, skipping to a next charging step in the plurality of charging steps in response to a battery cell voltage of the battery exceeding a predetermined battery cell voltage, and a temperature of the battery in a current step increasing by more than a predetermined temperature difference.

In other features, the predetermined SOC is less than 10%. The first ΔSOC, the second ΔSOC, the third ΔSOC, the fourth ΔSOC, the fifth ΔSOC, the sixth ΔSOC, the seventh ΔSOC, and the eighth ΔSOC are in a range from 2% to 10%. The method includes reducing the C-rate to a predetermined C-rate range for a predetermined period after one or more of the plurality of charging steps.

In other features, the one or more of the plurality of charging steps have one or more C-rates selected from a group consisting of 3C to 4C, 3−(1/n), 2+(1/n) C, and 2−(1/m), the predetermined C-rate range is from 0.1 C to 1 C, and the predetermined period is in a range from 1 minute to 2 minutes.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a battery charger for an electric vehicle according to the present disclosure;

FIG. 2 is an example of a table illustrating a first battery charging method according to the present disclosure;

FIGS. 3A to 3C is an example of a flowchart illustrating a battery charging method according to the present disclosure;

FIG. 4 is a graph illustrating an example of SOC %, current and charge rate as a function of time according to the present disclosure;

FIGS. 5A and 5B are graphs illustrating an example of SOC or voltage, respectively, charge rate, and current as a function of time during the first battery charging method according to the present disclosure;

FIG. 6 is a table illustrating an example of a second battery charging method according to the present disclosure;

FIG. 7 is a flowchart illustrating an example of the second battery charging method for charging at a lower C-rate after some of the charging steps according to the present disclosure; and

FIG. 8 is a graph illustrating an example of SOC %, current and charge rate as a function of time according to the present disclosure.

In the drawings, reference numbers may be reused to identify similar and/or identical elements.

### DETAILED DESCRIPTION

While the method for charging a battery pack including battery cells with lithium silicon oxide (LSO) is described in the context of EVs, the method for charging the battery pack can be used in stationary or other applications.

The battery cells of a battery pack include anode electrodes, cathode electrodes, separators, and/or electrolyte. The cathode electrodes include a cathode current collector and a cathode coating arranged on the cathode current collector. The cathode coating includes cathode active material, a binder, and/or other materials. The anode electrodes include an anode current collector and an anode coating arranged on the anode current collector. The anode coating includes anode active material, a binder, and/or other materials. In some examples, the anode electrodes and the cathode electrodes exchange lithium ions.

The anode active material may include lithium silicon oxide (Li_{y}SiOₓ or LSO) to increase energy density and/or reduce charging time. For example, the anode active material may include a mixture of graphite and LSO instead of only graphite as the anode active material.

The present disclosure relates to a charging method for charging the battery pack safely and quickly without damaging the battery cells in the battery pack. Current methods for charging lithium-based battery packs are not suitable for battery packs including battery cells with anode active material including LSO. For example, when direct current fast charging (DCFC) protocols are used for battery packs including battery cells with anode active material including LSO and graphite, the maximum cell voltage was exceeded at around 70% SOC. In addition, 80% ΔSOC takes more than one hour (e.g. for battery cells with 10% LSO anodes, ˜8.8 Ah cell format, 2.5-4.2V voltage range, compression pressure of 2 psi, and low HPPC at 1 C-rate). While the recharging time is shorter than prior battery charging protocols, the recharging time is too long for most consumers who are recharging while away from home.

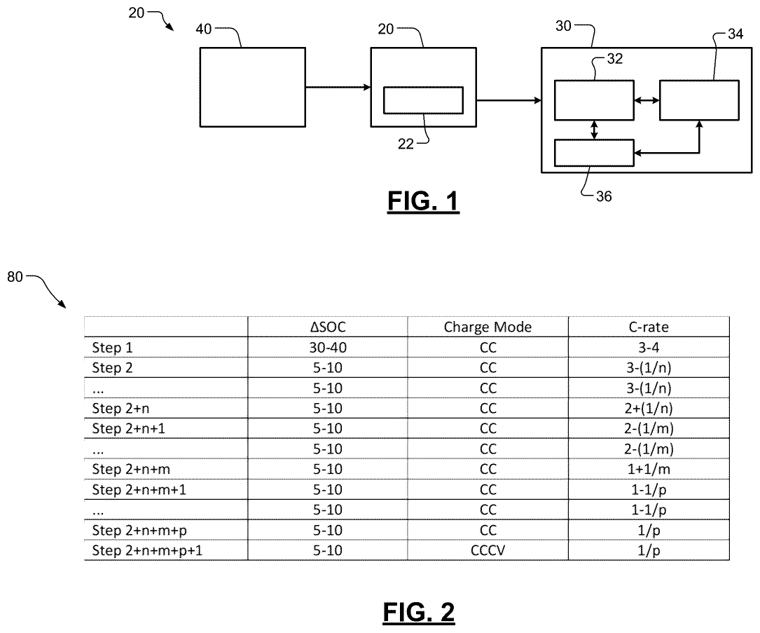

Referring now to FIG. 1, a battery charging system 10 for an electric vehicle 30 is shown. An electric vehicle (EV) charger 20 receives power from a utility 40 or other power source and includes a controller 22 configured to control power output from the utility to a battery pack 32 of the electric vehicle 30 using battery charging methods or protocols described further below. The electric vehicle 30 includes a battery management controller 34 configured to determine a state of charge, and sensors 36 such as voltage sensors, temperature sensors or other sensors. The battery pack 32 includes lithium-based battery cells with anode active material including LSO.

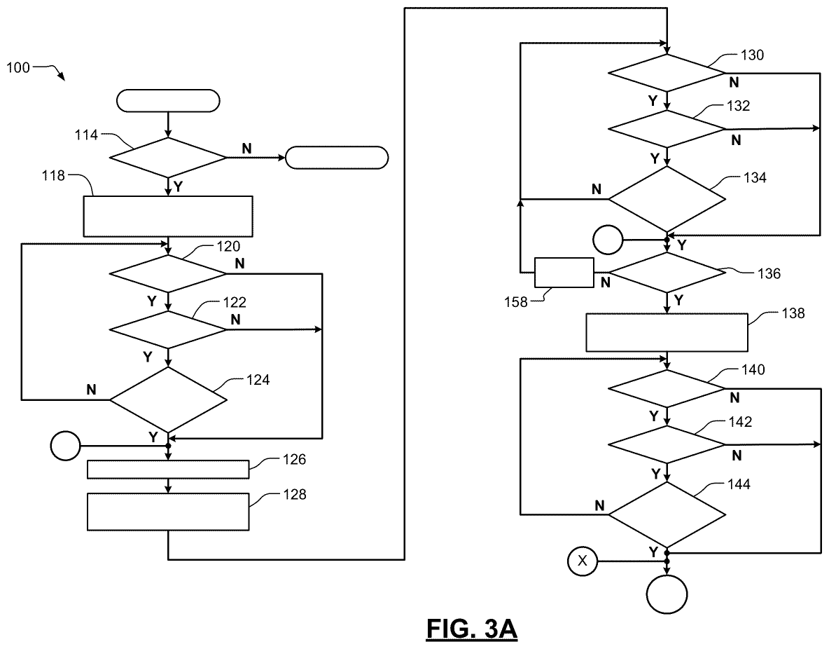

Referring now to FIG. 2, a table shows SOC, charge mode and a charge rate (C-rate) for a first battery charging method. In some examples, the first battery charging method is used when the starting SOC of the battery is in a predetermined range (e.g., 0% to 10% SOC) and stops when the SOC reaches a second predetermined range (e.g. 90% to 100%) (or when charging is interrupted at a lower SOC).

The C-rates are reduced in successive battery charging steps from 3 C to 4 C (in step 1), to 3−(1/n) C (in step(s) 2 to 2+n−1), to 2+(1/n) C (in step 2+n), to 2−(1/m) (in step(s) 2+n+1 to 2+n+m-1), to 1+(1/m) C (in step 2+n+m), to 1−(1/p) C (in step(s) 2+n+m+1 to 2+n+m+p−1), and then to 1/p C (in step 2+n+m+p), where n≥1, m ≥ 1, and p ≥ 1. Then, the first battery charging method optionally transitions to CCCV at 1/p C in step 2+n+m+p+1.

In some examples, n≥1, m≥1, and p≥1. In some examples, 3≤n≤15, 3≤m≤10, and 3≤p≤6. In some examples, the first battery charging method increases the SOC by ΔSOC in a predetermined range from 2% to 10% in each step (after the first charging step). In other examples, the first battery charging method increases the SOC by ΔSOC in a predetermined range from 5% to 10% in each step (after the first charging step).

In some examples, the anode active material of the anode electrodes includes LSO and graphite where the LSO comprises 10 wt. % to 70 wt. % and graphite comprises 30 wt. % to 90 wt. %.

The first battery charging method starts with a C-rate in a range from 3 C to 4 C until ΔSOC is in a range from 30% to 40%. If the temperature rises during a charging step greater than 20° C., the first battery charging method skips to the next step having a lower C-rate. If the battery cell voltage is greater than a predetermined maximum voltage (Vₘₐₓ) during a charging step, the first battery charging method skips to the next step having a lower C-rate. In some examples, the C-rate setting in each charging step is determined by the 3-electrode methodology to monitor the anode potential during the charging process.

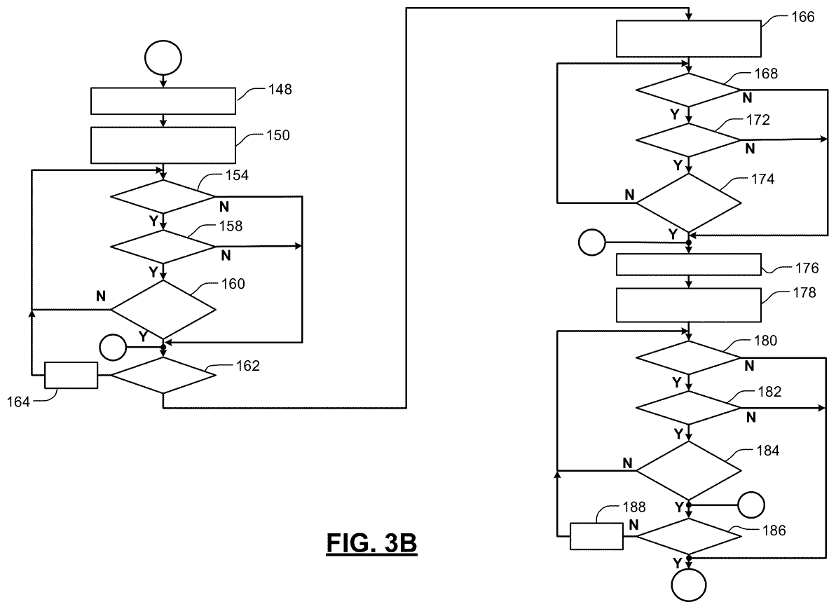

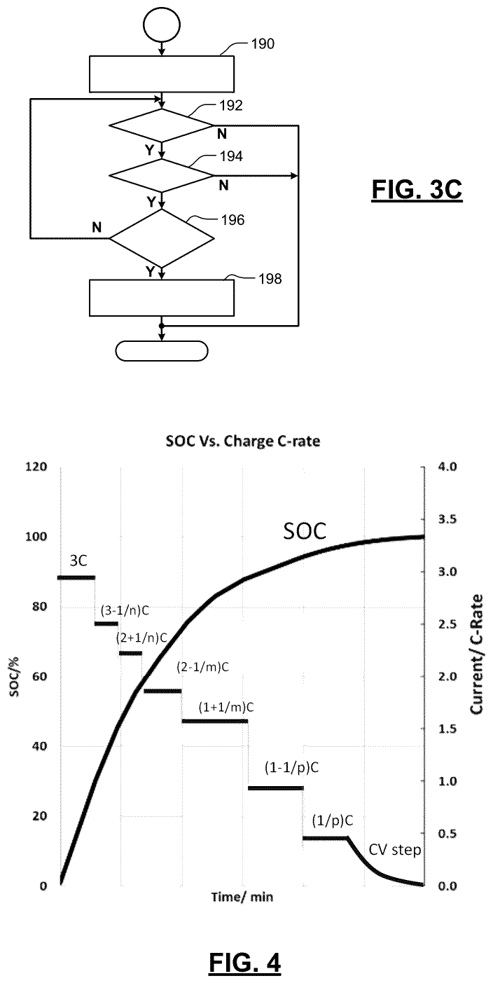

Referring now to FIGS. 3A to 3C, the first battery charging method 100 is shown. At 114, the method determines whether the SOC of the battery pack is less than a predetermined threshold TH. If 114 is true, the method continues at 118 and sets the C-rate in constant current (CC) mode in a range from 3 C to 4 C. During the battery charging, the cell voltage, SOC, temperature and/or other parameters are sampled, sent to the EV charger, and used to control the charging method.

At 120, the change in temperature ΔT1 during the charging step is compared to a predetermined temperature difference T1. At 120, the cell voltage V is compared to a maximum cell voltage threshold (Vₘₐₓ). At 124, the method determines whether the change in SOC (ΔSOC1) is greater than a threshold TH1. If the cell voltage exceeds Vₘₐₓ or the change in temperature exceeds T1, the method skips to the next charging step at a lower C-rate. In some examples, the threshold TH1 is in a range from 30 to 40. If 124 is false, the method returns to 120.

If 124 is true, the method continues at 126 and sets a counter g=0. At 128, the method sets the C-rate to 3−(1/n) C. At 130, the change in temperature ΔT2 during the charging step is compared to a predetermined temperature difference T2. At 132, the cell voltage V is compared to a maximum cell voltage threshold (Vₘₐₓ). If the cell voltage exceeds Vmax or the change in temperature exceeds T2, the method skips to the next charging step at a lower C-rate. At 134, the method determines whether the change in SOC (ΔSOC2) is greater than or equal to a threshold TH2. If 134 is false, the method returns to 130. If 134 is true, the method continues at 136. At 136, if g is less than n, the method increments g at 158 and returns to 130.

If g is greater than or equal to n, the method continues at 138. At 138, the method sets the C-rate to 2 + (1/n) C. At 140, the change in temperature ΔT3 during the charging step is compared to a predetermined temperature difference T3. At 142, the cell voltage V is compared to a maximum cell voltage threshold (Vₘₐₓ). If the cell voltage exceeds Vₘₐₓ or the change in temperature exceeds T3, the method skips to the next lower charging step at a lower C-rate. At 144, the method determines whether the change in SOC (ΔSOC3) is greater than or equal to a threshold TH3. If 144 is false, the method returns to 140.

If 144 is true, the method continues at 148 and sets a counter g=0. At 150, the method sets the C-rate to 2−(1/m) C. At 154, the change in temperature ΔT4 during the charging step is compared to a predetermined temperature difference T4. At 158, the cell voltage V is compared to a maximum cell voltage threshold (Vₘₐₓ). If the cell voltage exceeds Vₘₐₓ or the change in temperature exceeds T4, the method skips to the next charging step at a lower C-rate. At 160, the method determines whether the change in SOC (ΔSOC4) is greater than or equal to a threshold TH4. If 160 is false, the method returns to 154. If 160 is true, the method continues at 162. At 162, if g is less than m, the method increments g at 164 and returns to 154.

If g is greater than or equal to m, the method continues at 166. At 166, the method sets the C-rate to 1+(1/m) C. At 168, the change in temperature ΔT5 during the charging step is compared to a predetermined temperature difference T5. At 172, the cell voltage V is compared to a maximum cell voltage threshold (Vₘₐₓ). If the cell voltage exceeds Vₘₐₓ or the change in temperature exceeds T5, the method skips to the next lower charging step at a lower C-rate. At 174, the method determines whether the change in SOC (ΔSOC5) is greater than or equal to a threshold TH5. If 174 is false, the method returns to 168.

If 174 is true, the method continues at 176 and sets a counter g=0. At 178, the method sets the C-rate to 1−(1/p) C. At 180, the change in temperature ΔT5 during the charging step is compared to a predetermined temperature difference T5. At 182, the cell voltage V is compared to a maximum cell voltage threshold (Vₘₐₓ). If the cell voltage exceeds Vₘₐₓ or the change in temperature exceeds T6, the method skips to the next charging step at a lower C-rate. At 184, the method determines whether the change in SOC (ΔSOC6) is greater than or equal to a threshold TH6. If 184 is false, the method returns to 180. If 184 is true, the method continues at 186. At 186, if g is less than p, the method increments g at 188 and returns to 180.

If g is greater than or equal to p, the method continues at 190. At 190, the method sets the C-rate to (1/p) C. At 192, the change in temperature ΔT7 during the charging step is compared to a predetermined temperature difference T7. At 194, the cell voltage V is compared to a maximum cell voltage threshold (Vₘₐₓ). If the cell voltage exceeds Vₘₐₓ or the change in temperature exceeds T7, the method skips to the next charging step at a lower C-rate. At 196, the method determines whether the change in SOC (ΔSOC7) is greater than or equal to a threshold TH7. If 196 is false, the method returns to 192. If 196 is true, the method continues at 198 and sets the C-rate in a constant current/constant voltage (CCCV) mode to 1/p. Charging in the CCCV mode can continue until a predetermined SOC is reached (e.g., 90 to 100% SOC) or charging is interrupted.

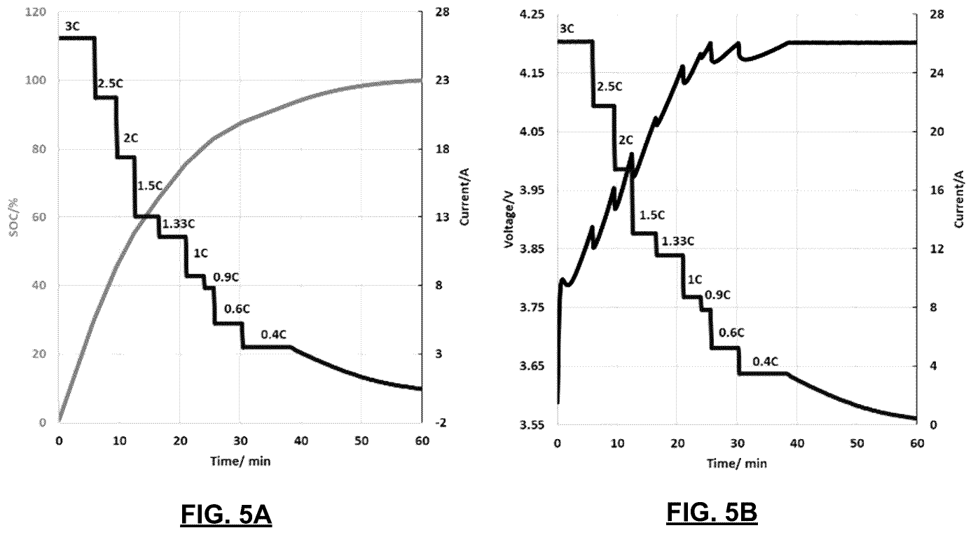

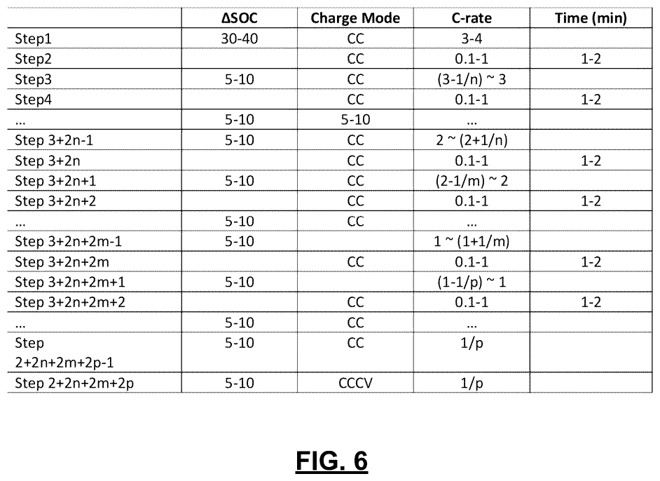

Referring now to FIGS. 4, 5A and 5B, SOC, current, voltage and/or C-rate are shown as a function of time. As can be seen in FIGS. 5A and 5B, the first battery charging method is capable of charging a battery pack including battery cells with anode active material including LSO to 80% ΔSOC charge in less 30 mins (e.g., 24 minutes) while maintaining voltage below Vₘₐₓ.

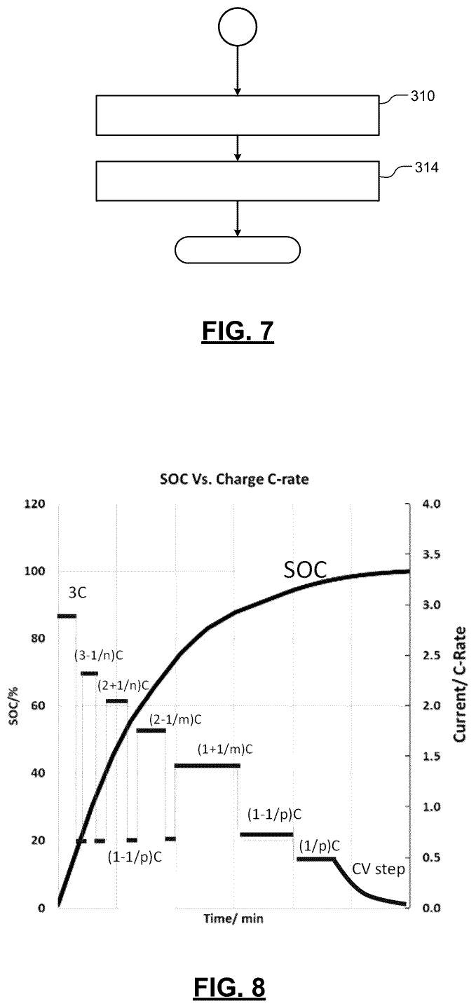

Referring now to FIGS. 6 to 8, a table shows SOC, charge mode and C-rate for a second battery charging method. The second charging method is similar to the first charging method except that the C-rate is reduced to a predetermined C-rate range (e.g., at 310 in FIG. 7) after some of the charging steps (e.g., see locations marked X in FIGS. 3A to 3C). The C-rates are reduced after charging steps at 3 C to 4 C, 3−(1/n) C, 2+(1/n) C, and 2−(1/m) C.

After a predetermined period at the lower C-rate (at 314 in FIG. 7), the method returns to the next charging step. In some examples, the predetermined C-rate range is in a range from 0.1 C to 1 C. In some examples, the predetermined period is in a range from 1 to 2 minutes. In FIG. 8, SOC % and current are shown as a function of time for the second battery charging method.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,”“engaged,”“coupled,”“adjacent,”“next to,”“on top of,”“above,”“below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method for charging a battery, comprising:
determining a state of charge (SOC) of the battery;
charging the battery using a plurality of charging steps including:
if the SOC of the battery is less than a predetermined SOC, charging the battery in a constant current mode at a first charge rate (C-rate) in a range from 3 C to 4 C in a first step until the SOC of the battery increases by a first ΔSOC;
after the first ΔSOC, charging the battery in the constant current mode at a second C-rate of 3−(1/n) C in a second step to (2+n−1)^{th} step until the SOC of the battery increases by a second ΔSOC, where n is an integer greater than zero; and
after the second ΔSOC, charging the battery in the constant current mode at a third C-rate of 2+(1/n) C in a (2+n)^{th} step until the SOC of the battery increases by a third ΔSOC.

2. The method of claim 1, wherein the plurality of charging steps further comprise, after the third ΔSOC, charging the battery in the constant current mode at a fourth C-rate of 2−(1/m) C in a (2+n+1) step to a (2+n+m−1) step until the SOC of the battery increases by a fourth ΔSOC, where m is an integer greater than zero.

3. The method of claim 2, wherein the plurality of charging steps further comprise, after the fourth ΔSOC, charging the battery in the constant current mode at a fifth C-rate of 1+(1/m) C in a (2+n+m)^{th} step until the SOC of the battery increases by a fifth ΔSOC.

4. The method of claim 3, wherein the plurality of charging steps further comprise, after the fifth ΔSOC, charging the battery in the constant current mode at a sixth C-rate of 1−(1/p) C in a (2+n+m+1)^{th} step to a (2+n+m+p−1)^{th} step until the SOC of the battery increases by a sixth ΔSOC, where p is an integer greater than zero.

5. The method of claim 4, wherein the plurality of charging steps further comprise, after the sixth ΔSOC, charging the battery in the constant current mode at a seventh C-rate of (1/p) C in a (2+n+m+p)^{th} step until the SOC of the battery increases by a seventh ΔSOC.

6. The method of claim 5, wherein the plurality of charging steps further comprise, after the seventh ΔSOC, charging the battery in a constant current/constant voltage mode at an eighth C-rate of (1/p) C in a (2+n+m+p+1)^{th} step until the SOC of the battery increases by a eighth ΔSOC.

7. The method of claim 1, further comprising skipping to a next charging step in the plurality of charging steps in response to a battery cell voltage of the battery exceeding a predetermined battery cell voltage.

8. The method of claim 1, further comprising skipping to a next charging step in the plurality of charging steps in response to a temperature of the battery in a current step increasing by more than a predetermined temperature difference.

9. The method of claim 1, wherein the predetermined SOC is less than 10%.

10. The method of claim 6, wherein the first ΔSOC, the second ΔSOC, the third ΔSOC, the fourth ΔSOC, the fifth ΔSOC, the sixth ΔSOC, the seventh ΔSOC, and the eighth ΔSOC are in a range from 2% to 10%.

11. The method of claim 4, wherein 3≤n≤15, 3≤m≤10, and 3≤p≤6.

12. The method of claim 1, further comprising reducing a C-rate to a predetermined C-rate range for a predetermined period after one or more of the plurality of charging steps.

13. The method of claim 12, wherein the one or more of the plurality of charging steps have one or more C-rates selected from a group consisting of 3 C to 4 C, 3−(1/n) C, 2+(1/n) C, and 2−(1/m) C.

14. The method of claim 12, wherein the predetermined C-rate range is from 0.1 C to 1 C.

15. The method of claim 12, wherein the predetermined period is in a range from 1 minute to 2 minutes.

16. A method for charging a battery, comprising:
determining a state of charge (SOC) of the battery;
charging the battery in a plurality of charging steps including:
if the SOC of the battery is less than a predetermined SOC, charging the battery in a constant current mode at a first charge rate (C-rate) in a range from 3 C to 4 C in a first step until the SOC of the battery increases by a first ΔSOC;
after the first ΔSOC, charging the battery in the constant current mode at a second C-rate of 3−(1/n) C in a second step to (2+n−1)^{th} step until the SOC of the battery increases by a second ΔSOC, where n is an integer greater than zero; and
after the second ΔSOC, charging the battery in the constant current mode at a third C-rate of 2+(1/n) C in a (2+n)^{th} step until the SOC of the battery increases by a third ΔSOC;
after the third ΔSOC, charging the battery in the constant current mode at a fourth C-rate of 2−(1/m) C in a (2+n+1) step to a (2+n+m−1) step until the SOC of the battery increases by a fourth ΔSOC, where m is an integer greater than zero;
after the fourth ΔSOC, charging the battery in the constant current mode at a fifth C-rate of 1+(1/m) C in a (2+n+m)^{th} step until the SOC of the battery increases by a fifth ΔSOC;
after the fifth ΔSOC, charging the battery in the constant current mode at a sixth C-rate of 1−(1/p) C in a (2+n+m+1)^{th} step to a (2+n+m+p−1)^{th} step until the SOC of the battery increases by a sixth ΔSOC, where p is an integer greater than zero;
after the sixth ΔSOC, charging the battery in the constant current mode at a seventh C-rate of (1/p) C in a (2+n+m+p)^{th} step until the SOC of the battery increases by a seventh ΔSOC; and
after the seventh ΔSOC, charging the battery in a constant current/constant voltage mode at an eighth C-rate of (1/p) in a (2+n+m+p+1)^{th} step until the SOC of the battery increases by an eighth ΔSOC.

17. The method of claim 16, further comprising skipping to a next charging step in the plurality of charging steps in response to:
a battery cell voltage of the battery exceeding a predetermined battery cell voltage; and
a temperature of the battery in a current step increasing by more than a predetermined temperature difference.

18. The method of claim 16, wherein:
the predetermined SOC is less than 10%; and
the first ΔSOC, the second ΔSOC, the third ΔSOC, the fourth ΔSOC, the fifth ΔSOC, the sixth ΔSOC, the seventh ΔSOC, and the eighth ΔSOC are in a range from 2% to 10%.

19. The method of claim 16, further comprising reducing the C-rate to a predetermined C-rate range for a predetermined period after one or more of the plurality of charging steps.

20. The method of claim 12, wherein:
the one or more of the plurality of charging steps have one or more C-rates selected from a group consisting of 3C to 4C, 3−(1/n), 2+(1/n) C, and 2−(1/m),
the predetermined C-rate range is from 0.1 C to 1 C, and the predetermined period is in a range from 1 minute to 2 minutes.
